(19) United States
(12) Patent Application Publication
(10) Pub. No.: US 2005/0024468 A1
(43) Pub. Date: Feb. 3, 2005

(54) Exposure unit and image forming apparatus provided with the exposure unit

(75) Inventors: Tadashi Ohba, Osaka (JP); Jun Nakai, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Kyocera Mita Corporation, Chuo-ku (JP)

(21) Appl. No.: 10/855,792

(22) Filed: May 28, 2004

(30) Foreign Application Priority Data
May 30, 2003 (JP) JP 2003-154505

(51) Int. Cl. B41J 2/385

(52) U.S. Cl. 347/133

(57) ABSTRACT

The object is to provide an exposure unit capable of forming an image without inconsistencies in density even when resolution in subscanning direction is N times larger than that in the main scanning direction. An image forming apparatus is provided with an exposure unit having an LED array with LED chips arranged linearly in the main scanning direction of a photosensitive body, and a control means for performing drive control of LED array on the basis of the drive current according to the drive data of which the electric current for lighting each LED device is corrected in accordance with variations in light amount, LED devices being lighted in a range of 1˜N times (N is a positive integer) for pixels aligning in subscanning direction per one scanning line to form latent dot images on the photosensitive body, wherein an electrostatic latent image is formed on the photosensitive body by performing the N times lighting control of LED devices so that the light intensity is corrected on the basis of the same correction current value based on the correction value calculated from the area of the beam emitted from each LED in accordance with tone density.

### BACKGROUND OF THE INVENTION

1. Field of the Invention

The present invention is related to an exposure unit to expose an image carrying body such as a photosensitive drum by use of LED array and an image forming apparatus provided with the exposure unit, specifically to an exposure unit using LED utilizing effectively a time shared exposing system in which luminous dots are formed by allowing LED devices arranged linearly to emit light simultaneously for each scanning line a plurality of times for pixels aligning in subscanning direction.

2. Description of the Related Art

Generally, an image forming apparatus such as a copying machine, printer, facsimile machine, etc. is provided with an exposure unit for exposing the image carrying body such as a photosensitive drum installed therein. An exposure unit mounted with a light printer head using LED(light emitting diode) array is known as an exposure unit for exposing the photosensitive drum in accordance with digital image information.

In the LED array of this type, the row of LED devices arranged linearly in the main scanning direction is controlled by time sharing to emit light with n-bit as a unit or with a scanning line as a unit in correspondence with image information, and exposed dot images are formed on a generatrix of a photosensitive drum to form electrostatic latent image of the dots. In an apparatus of this kind, generally the LED array is composed such that a plurality of chips of LED device, a shift resister for serially inputting n-bit data, and a drive IC in which a drive circuit, etc. for performing drive control of light emitting devices in said chips on the basis of parallel data from latch circuits and said shift register are integrated, are interconnected. An exposure unit (light printer head) with said LED array integrated therein is provided with a selfoc lens array composed of a plurality of selfoc lens for collecting beams emitted from the LED's and focusing them on a generatrix of the photosensitive drum and retaining members for holding these parts between the LED array and the photosensitive drum. In an image forming apparatus mounted with said light printer head, inclination of the printer head to the generatrix of the photosensitive drum may inevitably occur due to insufficient accuracy in assembling the light printer head and retaining members. This tendency is conspicuous in a tandem type color image forming apparatus with a plurality of printer heads. A commonly used measure for correcting said inclination is to allow each chip or each group of chips divided in a plurality of groups of chips to emit light with time difference in a scanning line in correspondence with the inclination of the LED array to form inclined line artificially. By this, the inclination of the light printer head is corrected.

However, when the resolution in subscanning direction is the same as that in main scanning direction(for example 600×600 dpi), an oblique line is formed into a step-formed straight line and the steps may be perceived by human eyes. To evade this, generally a time shared exposing system (see Japanese Patent Publication No.62-26626, Japanese Laid-Open Patent Application No. 60-134) is utilized with which a dot corresponding to a pixel is divided into N sub-dots in subscanning direction (N is an integer equal to or larger than 2) and the LED devices arranged along a main scanning line are allowed to emit light simultaneously for each main scanning line a plurality of times for pixels aligning in subscanning direction to depict an oblique line with resolution in subscanning direction increased by N times compared with that in main scanning direction, so that the steps in an oblique line are smoothed to an extent they are not perceived by human eyes.

For example, in the case of tripartite exposing in which exposing time is divided into three to increase resolution three(3) times in subscanning direction and light emitting time period of the LED corresponding to one dot(pixel) is reduced to one third(⅓), half-exposure and full-exposure are repeated for every ⅓ dot as shown in FIG. 6. As shown in (a)˜(f) in FIG. 6, by devising to allow each LED in the LED array to emit light so that ⅓^{th} sub-dot is half-exposure(see (a) in FIG. 6), ⅓^{th} sub-dot is full-exposure(see (b)), ⅓ th sub-dot is full-exposure and ⅔^{nd} sub-dot are full-exposure(see (c)), (⅓^{th}+⅔^{nd}) sub-dots are full-disposure (see(d)), (⅓^{th}+⅔^{nd}) sub-dots are half-disposure and ⅓ th sub-dot is half-disposure(see (e)), and (⅓^{th}+⅔^{nd}+3/3^{ird}) sub-dots are full-exposure, steps in an oblique line can be smoothed.

Now, as there are variations in luminance(light output) characteristic of said LED chips for each chip or each device due to differences in manufacturing condition when processing wafers, variations in light amount have been reduced to reduce inconsistency in light amount by controlling the energizing period or driving current of each device in correspondence with the characteristic of each chip and setting an optimal electric current for each device so that the light amount emitted from each devices is identical. However, as the lens array of a light printer head is composed of a number of cylinder lens, there occur variations in beam area formed on the imaging surface of a photosensitive drum due to variations in imaging error resulting in occurrence of inconsistencies in density even if the light amount emitted from each device is identical. As a corrective action for this, inconsistencies in density have been corrected by assigning to each light emitting device a current value calculated based on the area of imaged beam(hereafter referred to as beam correction).

For example, in an image forming apparatus having a means to form dots of multi-step gradation, the optimal electric current value is determined in accordance with the number of steps of gradation to reduce inconsistencies in density, wherein light amount is reduced for a beam of large image area and light amount is increased for a beam of small image area in a high tone image as dots are congested therein, light amount is reduced for a beam of small image area and light beam is increased for a beam of large image area in a low tone image as dots are scattering therein.

However, if said beam correction is applied to the time shared exposing system in which the resolution in subscanning direction is increased to N times that in main scanning direction, for example, if said beam correction is performed in the case as shown in FIG. 5 which shows the number of gradation steps (gradation steps per 1 dot) vs. beam correction currents, beam correction is done for 1 dot in correspondence with the straight line A represented by the continuation of solid triangular marks. (In FIG. 5, beam correction currents are defined for 16 steps of density gradation, the current value is 20 for 5^{th} step of density gradation, 15 for 10^{th} step of gradation, and 10 for 15 ^{th} step of density gradation, and each LED device emits light of 16 levels of light intensity according to the beam correction current corresponding to the number of steps of gradation.)

When said correction is applied to the case of time shared exposing system in which, for example, the resolution in subscanning direction is increased to 3 times that in main scanning direction, the correction is done so that correction line A in FIG. 5 changes in inclination in correspondence with the shortening of light emitting time period to one third(⅓) and correction is done for each ⅓ dot in correspondence with line B1, B2, and B3 represented by continuing solid squares respectively. Accordingly, a correction value corresponding line A which is a correction line for 1 dot is not selected, and beam correction in 1 dot is not performed appropriately resulting in inefficient correction.

### SUMMARY OF THE INVENTION

An object of the present invention is to provide an LED exposure unit with which beam correction does not become ineffective even when a time shared exposing system in which the resolution in subscanning direction is N (positive integer) times larger than that in main scanning direction is adopted, and an image forming apparatus provided with the exposure unit.

Another object of the invention is to provide an LED exposure unit capable of reducing substantially the occurrence of inconsistencies in density or banding in an image which has not been able to be suppressed efficiently by light amount controlling only.

The present invention proposes an exposure unit having an LED array with LED chips arranged linearly in the main scanning direction of a photosensitive body, and a control means for performing drive control of said LED array on the basis of the drive current according to the drive data of which the predetermined electric current is corrected in accordance with variations in light amount, said LED devices being lighted in a range of 1˜N times (N is a positive integer) for pixels aligning in subscanning direction per one scanning line to form latent dot images on the photosensitive body, wherein said N times lighting control of LED devices is performed so that the light intensity is corrected on the basis of the same correction current value based on the correction value calculated from the area of the beam emitted from each LED in accordance with tone density.

For example, said control means allows, when 1 latent dot image is divided into N sub-dots to be exposed by time sharing, 1 dot to be exposed according to tone density as 1/N^{th} sub-dot, 1/N^{th}+2/N^{nd} sub-dots, 1/N^{th}+2/N^{nd}+3/N^{ird} sub-dots, . . . . When performing time shared exposing, beam correction for each divided exposure is not done in accordance with the beam correction current values on correction lines B1, B2, and B3 represented by continuation of solid squares as shown in FIG. 5, but correction values are established based on a moving average line of the tone density controlled on the basis of light emitting time period necessary to form the latent image of 1 dot to be formed on the image carrying body as shown by correction line A in FIG. 5.

In this way, by controlling light emitting time period for every tone according to pixel data through performing tone control of the LED devices lighted in a range of 1˜N times (N is a positive integer) for pixels aligning in subscanning direction per one main scanning line, the occurrence of a phenomenon that beam correction is invalidated and inconsistencies in density occur even when resolution is N times larger in subscanning direction than in main scanning direction.

Further, according to the present invention, an image forming apparatus which is provided with said exposure unit, forms an electrostatic latent image on said photosensitive body by means of said exposure unit, develops the latent image to obtain a toner image, and transfers the toner image to a recording medium, can be obtained.

### BRIEF DESCRIPTION OF THE DRAWINGS

FIG. 1 is a diagrammatical side view of a color printer provided with the exposure unit of the present invention.

FIG. 2 is a diagrammatical plan view of an example of the exposure unit of the present invention.

FIG. 3 is a block diagram showing an example of the controller for controlling the exposure unit of FIG. 2.

FIG. 4 is a drawing for explaining the process of dot formation through lighting control by the controller of FIG. 3.

FIG. 5 is a graph showing the relation of current value for beam correction to the number of gradation steps in 1 dot.

FIG. 6 is a drawing for explaining the process of dot formation by conventional lighting control.

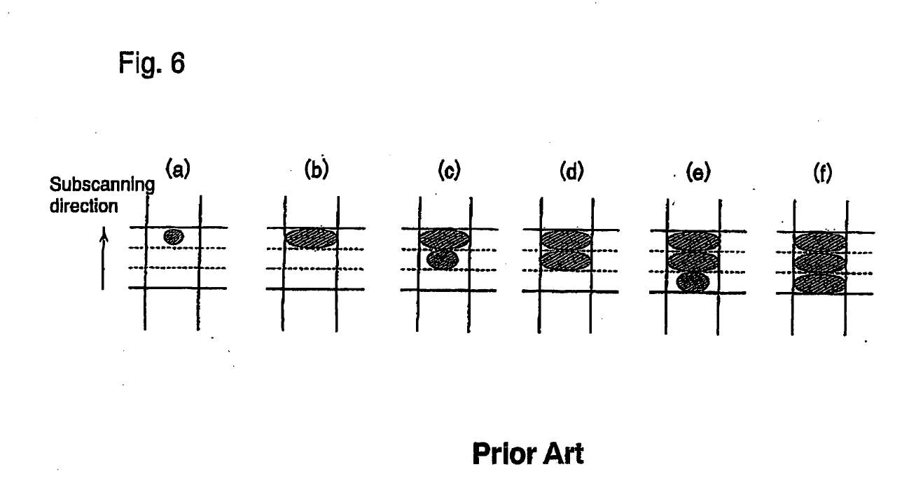

### DETAILED DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

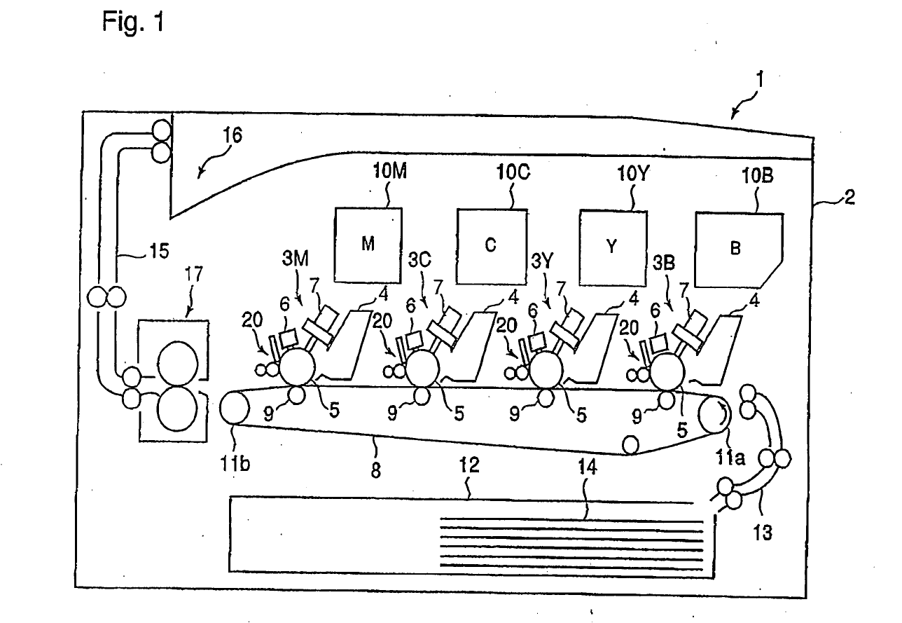

First, the image forming apparatus provided with the exposure unit according to the present invention will be explained referring to FIG. 1. Here, an LED array type exposure unit is used as an exposure unit, and the image forming apparatus is a color printer.

A color printer 1 has a printer housing 2 (hereafter referred to merely as a housing), and in the housing 2 are located image forming sections 3B, 3Y, 3C, and 3M of black, yellow, cyan, and magenta respectively and toner hoppers 10B, 10Y, 10C, and 10M for black, yellow, cyan, and magenta respectively.

In the housing are provided a paper feed cassette 12 with recording sheets 14 accommodated therein, and the recording sheets are sent out from the paper feed cassette 12 one by one passing through a paper feed guide 13.

As shown in the drawing, a transfer belt 8 is looped over a drive roller 11a and a follower roller 11b, and the image forming section of each color 3B, 3Y, 3C, and 3M is provided with a developing means 4, a photosensitive drum 5, a main electric charger 6, an LED exposure unit 7, a cleaning means 20, etc.

Each of the photosensitive drums 5 faces each of transfer rollers 9 across the transfer belt 8 in each of the image forming sections 3B, 3Y, 3C, and 3M. A fusing station 17 is located downstream of the transfer belt 8, and the recording sheet 14 passed through the fusing station 17 advances through guide chute 15 to a catch tray 16.

When performing color image formation, the surface of the photosensitive drum 5 is charged uniformly by the main charger 6, the photosensitive drum 5 is exposed to the light emitted from the LED array in accordance with image data, and an electrostatic latent image is formed on the surface of the photosensitive drum 5. Then, the electrostatic latent image is developed by the developing means 4, and a toner image is formed on the photosensitive drum 5.

Such process as mentioned above is performed for each color, images of each color are transferred sequentially to the recording sheet 14 by the transfer roller 9 when the recording sheet 14 fed from the paper feed cassette 12 and guided through the paper feed guide 13 to be transferred on the transfer belt 8 passes immediately under each image forming section of each color of 3B, 3Y, 3C, and 3M, and a color toner image is formed on the recoding sheet 14.

The recording sheet 14 on which a color toner image is formed is advanced to the fusing station 17 whereby the color toner image is permanently affixed to the recording sheet 14. Then the recording sheet 14 is advanced through the guide chute 15 to the catch tray 16.

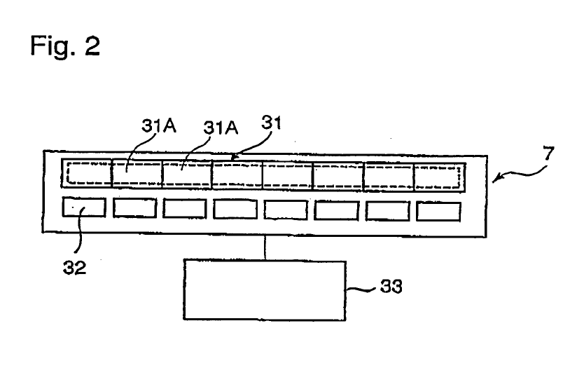

Referring to FIG. 2, the LED array exposure unit 7 is provided with an LED array 31 consisting of a plurality of LED devices with a chip 31A as a unit, which is arranged in the axial direction of the photosensitive drum(in main scanning direction) , and these LED devices are driven by LED drive circuits(driving IC) 32.

The LED drive circuits 32 are controlled through the controller 33 so that the LED devices are dynamic-drive -controlled by every chip or by a group of chips. Now, in the color printer shown in FIG. 1 for example, print data(image data) is sent from an outside PC (personal computer, not shown in the drawing), etc., the controller 33 controls the driving of the LED device of each chip through the LED driving circuit 32. The light emitted from the LED device integrated in each of the chips 31A is imaged as a dot on the photosensitive drum 5 by means of lens array(not shown in the drawing).

When resolution is N times larger in the direction of rotation of the photosensitive drum 5(in subscanning direction) than in main scanning direction (N is an integer equal to or larger than 2), for example when N is 3, the exposure time for 1 dot of latent image(l pixel) is tripartitioned in subscanning direction and each LED device is lighted three times for 1 dot in accordance with image tone density.

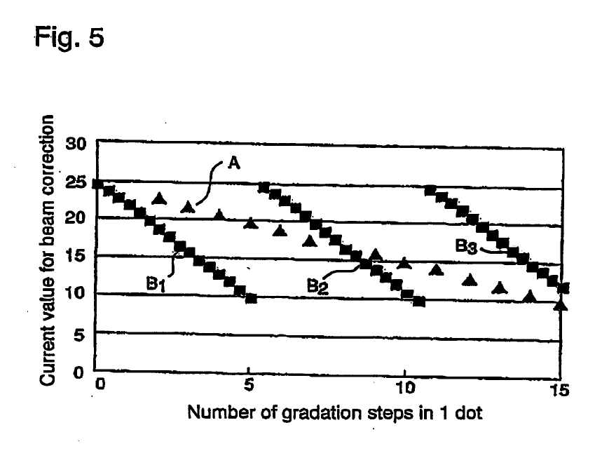

To perform beam correction of each LED device to be lighted, the controller 33 is provided with a correction value memory 42 for memorizing correction value presented by correction current line A in FIG. 5, the line defining correction current values in accordance with the tone density in 1 dot as explained before. The correction current values are calculated for example based on the result of measurement of the relation between drive current and the number of steps of gradation measured beforehand.

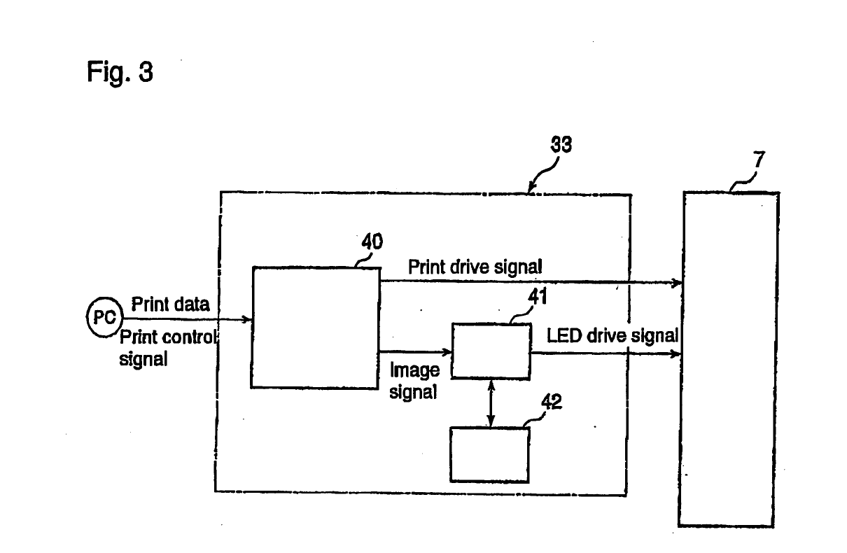

Referring to FIG. 3, the controller 33 shown in FIG. 2 is provided with a print controlling section 40 for performing dynamic drive, a correction circuit 41 for correcting the light intensity of each LED device in accordance with image tone density based on the correction current value from the correction current value memory 42, and said correction current value memory 42. As to drive control when exposing the photosensitive drum 5 and N is 3, print data(image data) and print controlling signals are given from a PC(personal computer) to the print control section 40.

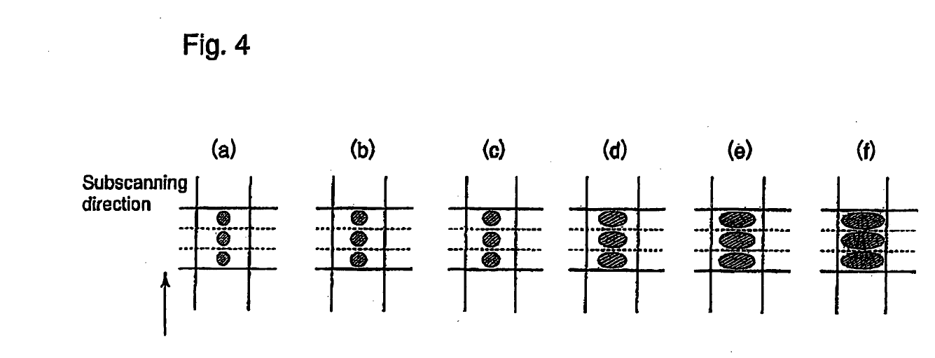

Referring to FIG. 3 and FIG. 4, the process of correction will be explained hereunder.

With the configuration shown in FIG. 3, first, raster-processed print data(resolved into pixels) is sent from the print driver of the PC together with print control signals to the print control section 40. Sensitivity data of the photosensitive drum prepared beforehand is given to the correction circuit 41. The sensitivity data of the photosensitive drum may be inputted from the operating section (not shown in the drawings) of the color printer 1 when assembling or replacing the photosensitive drum or is possible to be inputted and memorized in the PC so that the data can be given from the print driver of the PC. Then, the print control section 40 divides the image information of every scanning line into N pieces and sends the divided image information to the correction circuit 41, and at the same time sends a print drive signal to the LED array exposure unit 7 to start printing. The correction circuit 41 receives the divided image information and the sensitivity data of the photosensitive drum, read the correction current value of FIG. 5 for correcting the light amount of the LED device to be energized, and sends it as a corrected image signal for split-driving the LED devices by 1 scanning block unit to the LED array exposure unit 7 together with a clock signal for timing. At this time, the amount of the corrected image signals sent to the exposure unit 7 is a scanning blockful of data divided in a plurality of scanning blockful data, and a latch signal is also sent to allow the LED array of the exposure unit 7 to emit light according to said blockful data on the basis of the same correction value with time shared exposure timing of the exposure unit 7.

The LED drive circuits 32 performs drive control of the LED devices corresponding to the image information of the LED array 31 in correspondence with the LED driving signal to allow the LED devices to be lighted three times for pixels aligning in subscanning direction by the correction current based on said correction value as shown in FIG. 4(a)˜(f).

The controller 33 performs dynamic drive control for every chip or for a group of a certain number of chips sequentially in main scanning direction. By this, when the latent dot image is formed divided into three as shown in FIG. 4(b)˜(f) by time shared exposing, the dot image is split-exposed as ⅓^{th}sub-dot, ⅓^{th}+⅔^{nd} sub-dots, ⅓^{th}+⅔^{nd}+3/3^{ird} sub-dots. At this time, the correction value for every divided exposure is determined based on a moving average line of the tone density controlled on the basis of lighting time period necessary to form the latent image of 1 dot to be formed on the image carrying body, as shown by correction line A in FIG. 5.

For example, when resolution is 600 dpi and 1 scanning block is divided into three and time shared exposing is done for every ⅓ dot, if the tone density is 7/15 level, every ⅓ dot is formed by allowing the LED devices controlled based on the correction value corresponding to 7/15 level of tone density to emit light of the same intensity. As a result, a latent dot image divided into 3 of ⅓ dot is formed as 1 dot latent image for every scanning block with corresponding tone density.

By lighting LED devices three times for pixels aligning in subscanning direction based on the same correction current to form three ⅓ dots as mentioned above, each ⅓ dot is formed smoothed in main scanning direction corresponding to tone density.

That is, by performing beam correction in which the light amount of each divided dot of 1 dot is controlled so that it is the same as the light amount when the dot is not divided, inconsistencies in density do not occur.

A test was done with the condition as follows:

OPC photoreceptor was used as the photosensitive drum 5.

Electric potential of the surface of the photosensitive drum before exposure was set to 400 V, half light amount to 0.17 μJ/cm², line speed to 100 mm/sec. Light printer head 7 for A4 size with resolution of 600 dpi in main scanning direction was used, resolution in subscanning direction was set to 1800 dpi(i.e. the N=3), and exposing light amount was set to 0.7 μa J/cm², wave length to 770 nm. Exposure control was done as mentioned above.

The result of the test was as follows:

When dot division was not done(when dots was not divided in subscanning direction( when LED array has one LED device in subscanning direction)), the condition to obtain a uniform image by tone correction in 1 dot was that the granularity of image, which is an indicator representing image surface roughness (dot tone density), was 0.0022 in a half-image (beam area of 1 dot is 25% of that of a full-image). Compared with this, when lighting control according to the invention was done, the condition was 0.0010. Thus, it was recognized that image density becomes more uniform.

### EFFECT OF THE INVENTION

As has been explained in the foregoing, according to the present invention, when controlling the lighting of LED devices arranged linearly in main scanning direction to allow the devices to be lighted a plurality of times for pixels aligning in subscanning direction so that the resolution in the subscanning direction of an image carrying body is N times larger than that in the main scanning direction thereof, the LED devices are controlled to be lighted based on the correction value established in correspondence with tone density, and lighting time period is controlled for every tone density according to pixel information. Therefore, inconsistencies in density and banding do not occur even if the resolution in subscanning direction is N times larger than that in main scanning direction.

1. An exposure unit having an LED array with LED chips arranged linearly in a main scanning direction of a photosensitive body, and a control means for performing drive control of said LED array on a basis of drive current according to drive data of which predetermined electric current for lighting each LED device is corrected in accordance with variations in light amount, said LED devices being lighted in a range of 1˜N times(N is a positive integer) for pixels aligning in subscanning direction per one scanning line to form latent dot images on the photosensitive body, wherein said N times lighting control of LED devices is performed so that light intensity is corrected on the basis of the same correction current value based on the correction value calculated from the area of the beam emitted from each LED in accordance with tone density.

2. The exposure unit according to claim 1, wherein said correction value is established on a basis of a moving average line of the tone density determined based on light emitting time period necessary to form a latent dot image for every scanning block on the photosensitive body.

3. An image forming apparatus provided with an exposure unit having an LED array with LED chips arranged linearly in a main scanning direction of a photosensitive body, and a control means for performing drive control of said LED array on a basis of drive current according to drive data of which predetermined electric current is corrected in accordance with variations in light amount, said LED devices being lighted in a range of 1˜N times (N is a positive integer) for pixels aligning in subscanning direction per one scanning line to form latent dot images on the photosensitive body, wherein an electrostatic latent image is formed on the photosensitive body by performing said N times lighting control of LED devices so that light intensity is corrected on the basis of the same correction current value based on the correction value calculated from the area of the beam emitted from each LED in accordance with tone density.
